(19) United States
(12) Patent Application Publication
(10) Pub. No.: US 2010/0093905 A1
(43) Pub. Date: Apr. 15, 2010

(54) AQUEOUS BINDER FOR GRANULAR AND/OR FIBROUS SUBSTRATES

(75) Inventors: Oihana ELIZALDE, Mannheim (DE); Kathrin Michl, Ludwigshafen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/577,858

(22) Filed: Oct. 13, 2009

(30) Foreign Application Priority Data
Oct. 15, 2008 (EP) 08166695.0

(51) Int. Cl. C08K 5/06; B05D 3/02

(52) U.S. Cl. 524/378; 427/385.5

(57) ABSTRACT

Aqueous binders for granular and fibrous substrates, based on hydrophobically modified polymers.

The subject matter of the present invention relates to an aqueous binder for granular and/or fibrous substrates, comprising as active constituents
a) a polymer obtainable by free-radical addition polymerization and comprising in copolymerized form
   0.1% to 40% by weight of at least one C₃ to C₃₀ alkene (monomer A1),
   40% to 99.9% by weight of at least one ethylenically unsaturated C₃ to C₆ monocarboxylic acid (monomer A2),
   0% to 50% by weight of at least one ethylenically unsaturated C₄ to C₁₂ dicarboxylic acid and/or of the ethylenically unsaturated dicarboxylic monoalkyl esters or dicarboxylic anhydrides obtainable from said acid (monomer A3), and
   0% to 30% by weight of at least one other ethylenically unsaturated compound which is copolymerizable with the monomers A1 to A3 (monomer A4),
   the amounts of monomers A1 to A4 adding up to 100% by weight [polymer A],
b) a polymer obtainable by free-radical addition polymerization and comprising in copolymerized form 0.1% to 15% by weight of at least one ethylenically unsaturated compound containing at least one carboxyl, hydroxyalkyl, epoxy, methylol, silyl and/or oxazolinyl group [monomer B1] and 85% to 99.9% by weight of at least one other ethylenically unsaturated compound [monomer B2] which is copolymerizable with the monomer B1, the amounts of monomers B1 and B2 adding up to 100% by weight [polymer B], and
c) a polyol compound having at least two hydroxyl groups [polyol C].

The present invention further relates to a process for producing shaped articles using the binder of the invention, and also to the shaped articles thus produced themselves.

The consolidation of fibrous or granular substrates, more particularly in sheetlike structures, exemplified by fiber webs, fiberboards or chipboard panels, etc., is frequently accomplished chemically using a polymeric binder. To increase the strength, particularly the wet strength and thermal stability, in many cases binders are used which comprise crosslinkers that give off formaldehyde. As a consequence of this, however, there is a risk of unwanted formaldehyde emission.

For the purpose of avoiding formaldehyde emissions there have already been numerous alternatives proposed to the binders known to date. For instance U.S. Pat. No. 4,076,917 discloses binders which comprise carboxylic acid-containing or carboxylic anhydride-containing polymers and β-hydroxyalkylamide crosslinkers. A disadvantage is the relatively costly and inconvenient preparation of the β-hydroxyalkylamides.

EP-A 445578 discloses boards made of finely divided materials, such as glass fibers, for example, in which mixtures of high molecular weight polycarboxylic acids and polyhydric alcohols, alkanolamines, or polyfunctional amines act as binders.

EP-A 583086 discloses formaldehyde-free aqueous binders for producing fiber webs, more particularly glass fiber webs. The binders comprise a polycarboxylic acid having at least two carboxylic acid groups and also, if appropriate, anhydride groups, and a polyol. These binders require a phosphorous-containing reaction accelerant in order to attain sufficient strengths on the part of the glass fiber webs. It is noted that the presence of such a reaction accelerant is vital unless a highly reactive polyol is used. Highly reactive polyols specified include β-hydroxyalkylamides.

EP-A 651088 describes corresponding binders for substrates made from cellulosic fiber. These binders necessarily comprise a phosphorous-containing reaction accelerant.

EP-A 672920 describes formaldehyde-free binding, impregnating or coating compositions which comprise at least one polyol and a polymer which is composed to an extent of 2% to 100% by weight of an ethylenically unsaturated acid or acid anhydride comonomer. The polyols are substituted triazine, triazinetrione, benzene or cyclohexyl derivatives, and the polyol radicals are always located in positions 1, 3, and 5 of the aforementioned rings. In spite of a high drying temperature, the wet tensile strengths obtained with these binders on glass fiber webs are low.

DE-A 2214450 describes a copolymer composed of 80% to 99% by weight of ethylene and 1% to 20% by weight of maleic anhydride. Together with a crosslinking agent, the copolymer is used in powder form or in dispersion in an aqueous medium for the purpose of surface coating. The crosslinking agent used is a polyalcohol which contains amino groups. In order to bring about crosslinking, however, heating must be carried out at up to 300° C.

U.S. Pat. No. 5,143,582 discloses the production of heat-resistant nonwoven-web materials using a thermosetting heat-resistant binder. The binder is formaldehyde-free and is obtained by mixing a crosslinker with a polymer containing carboxylic acid groups, carboxylic anhydride groups or carboxylic salt groups. The crosslinker is a β-hydroxy-alkylamide or a polymer or copolymer thereof. The polymer crosslinkable with the β-hydroxyalkylamide is synthesized, for example, from unsaturated monocarboxylic or dicarboxylic acids, salts of unsaturated monocarboxylic or dicarboxylic acids, or unsaturated anhydrides. Self-curing polymers are obtained by copolymerizing the β-hydroxyalkylamides with monomers comprising carboxyl groups.

Processes for the preparation of polymers based on alkenes and other copolymerizable ethylenically unsaturated compounds are well known to the skilled worker. The copolymerization takes place essentially in the form of a solution polymerization (see, for example, A. Sen et al., Journal American Chemical Society, 2001, 123, pages 12 738 to 12 739; B. Klumperman et al., Macromolecules, 2004, 37, pages 4406 to 4416; A. Sen et al., Journal of Polymer Science, Part A: Polymer Chemistry, 2004, 42(24), pages 6175 to 6192; WO 03/042254, WO 03/091297 or EP-A 1384729) or in the form of an aqueous emulsion polymerization, this taking place more particularly on the basis of the lowest alkene, ethene (see, for example, U.S. Pat. No. 4,921,898, U.S. Pat. No. 5,070,134, U.S. Pat. No. 5,110,856, U.S. Pat. No. 5,629,370, EP-A 295727, EP-A 757065, EP-A 1114833 or DE-A 19620817).

The following is prior art for free-radically initiated aqueous emulsion polymerization using higher alkenes:

DE-A 1720277 discloses a process for preparing film-forming aqueous addition-polymer dispersions using vinyl esters and 1-octene. The weight ratio of vinyl ester to 1-octene can be from 99:1 to 70:30. Optionally the vinyl esters can be used to a minor extent in a mixture with other copolymerizable ethylenically unsaturated compounds for the emulsion polymerization.

S. M. Samoilov in J. Macromol. Sci. Chem., 1983, A19(1), pages 107 to 122 describes the free-radically initiated aqueous emulsion polymerization of propene with different ethylenically unsaturated compounds. The outcome observed there was that the copolymerization of propene with ethylenically unsaturated compounds having strongly electron-withdrawing groups, such as chlorotrifluoroethylene, trifluoroacrylonitrile, maleic anhydride or methyl trifluoroacrylate, gave polymers having a markedly higher propene fraction, or copolymers having higher molecular weights, than when using the ethylenically unsaturated compounds typically associated with free-radically initiated aqueous emulsion polymerization, viz. vinyl acetate, vinyl chloride, methyl acrylate and/or butyl acrylate. The reasons given for this behavior include more particularly the hydrogen radical transfer reactions that are typical of the higher alkenes.

The preparation of aqueous addition-polymer dispersions based on different, extremely water-insoluble monomers by free-radically initiated emulsion polymerization using host compounds is disclosed in U.S. Pat. No. 5,521,266 and EP-A 780401.

DE-A 102005035692 discloses the preparation of aqueous addition-polymer dispersions based on alkenes having 5 to 12 C atoms. The alkenes having 5 to 12 C atoms are metered into the polymerization mixture under polymerization conditions.

EP-A 891430 discloses aqueous polymer systems for imparting water repellency to leather, said systems being obtained by free-radical polymerization of 20% to 90% by weight of monoethylenically unsaturated C₄ to C₆ dicarboxylic acids and/or their anhydrides with 5% to 50% by weight of a C₂ to C₆ olefin and 5% to 50% by weight of a hydrophobic ethylenically unsaturated monomer.

EP-A 670909 discloses aqueous polymer dispersions which are used as a component for fatliquoring or softening leather and which are obtained by free-radical polymerization of maleic anhydride, C₁₂ to C₃₀ α-olefins, and esters of acrylic acid, methacrylic acid and/or maleic acid with C₁₂ to C₃₀ alcohols.

Coating compositions based on a crosslinker, such as an endgroup-capped polyisocyanate or an amino resin, for example, and on an emulsion polymer based on α-olefins and ethylenically unsaturated carboxylic anhydrides are disclosed in EP-A 450-452.

E. Witek, A. Kochanowski, E. Bortel, Polish Journal of Applied Chemistry XLVI, no. 3-4, pages 177-185 (2002), describe the use of copolymers based on long-chain α-olefins and hydrophilic monomers, such as acrylic acid and/or maleic anhydride, for example, for removing crude-oil contamination in water.

A priority-founding patent application filed by the applicant at the European Patent Office and bearing the file reference 07118135.8 discloses the preparation of acid polymers and the use of the acid polymers and polyols as components in binders for fibrous and/or granular substrates.

It was an object of the present invention to provide a formaldehyde-free binder system for granular and/or fibrous substrates, which in comparison to the prior-art binders has a lower yellowing tendency and an improved wet tensile strength.

The aqueous binder defined at the outset has been found accordingly.

In accordance with the invention an aqueous binder is used which comprises a polymer A which is obtainable by free-radical addition polymerization and comprises in copolymerized form

0.1% to 40% by weight of at least one monomer A1,
40% to 99.9% by weight of at least one monomer A2,
0% to 50% by weight of at least one monomer A3, and
0% to 30% by weight of at least one monomer A4.

With particular advantage, aqueous binders are used which comprise a polymer A which is obtainable by free-radical addition polymerization and comprises in copolymerized form

1% to 25% by weight of at least one monomer A1,
50% to 89% by weight of at least one monomer A2, and
10% to 40% by weight of at least one monomer A3,
and with more particular advantage
4% to 16% by weight of at least one monomer A1,
55% to 70% by weight of at least one monomer A2, and
20% to 35% by weight of at least one monomer A3.

Monomers A1 contemplated are C₃ to C₃₀ alkenes, preferably C₆ to C₁₈ alkenes, and more particularly C₈ to C₁₂ alkenes which can be copolymerized free-radically and which apart from carbon and hydrogen have no further elements. They include, for example, the linear alkenes propene, n-but-1-ene, n-but-2-ene, 2-methylpropene, 2-methylbut-1-ene, 3-methylbut-1-ene, 3,3-dimethyl-2-isopropylbut-1-ene, 2-methylbut-2-ene, 3-methylbut-2-ene, pent-1-ene, 2-methylpent-1-ene, 3-methylpent-1-ene, 4-methylpent-1-ene, pent-2-ene, 2-methylpent-2-ene, 3-methylpent-2-ene, 4-methylpent-2-ene, 2-ethylpent-1-ene, 3-ethylpent-1-ene, 4-ethylpent-1-ene, 2-ethylpent-2-ene, 3-ethylpent-2-ene, 4-ethylpent-2-ene, 2,4,4-trimethylpent-1-ene, 2,4,4-trimethylpent-2-ene, 3-ethyl-2-methylpent-1-ene, 3,4,4-trimethylpent-2-ene, 2-methyl-3-ethylpent-2-ene, hex-1-ene, 2-methylhex-1-ene, 3-methylhex-1-ene, 4-methylhex-1-ene, 5-methylhex-1-ene, hex-2-ene, 2-methylhex-2-ene, 3-methylhex-2-ene, 4-methylhex-2-ene, 5-methylhex-2-ene, hex-3-ene, 2-methylhex-3-ene, 3-methylhex-3-ene, 4-methylhex-3-ene, 5-methylhex-3-ene, 2,2-dimethylhex-3-ene, 2,3-dimethylhex-2-ene, 2,5-dimethylhex-3-ene, 2,5-dimethylhex-2-ene, 3,4-dimethylhex-1-ene, 3,4-dimethylhex-3-ene, 5,5-dimethylhex-2-ene, 2,4-dimethylhex-1-ene, hept-1-ene, 2-methylhept-1-ene, 3-methylhept-1-ene, 4-methylhept-1-ene, 5-methylhept-1-ene, 6-methylhept-1-ene, hept-2-ene, 2-methylhept-2-ene, 3-methylhept-2-ene, 4-methylhept-2-ene, 5-methylhept-2-ene, 6-methylhept-2-ene, hept-3-ene, 2-methylhept-3-ene, 3-methylhept-3-ene, 4-methylhept-3-ene, 5-methylhept-3-ene, 6-methylhept-3-ene, 6,6-dimethylhept-1-ene, 3,3-dimethylhept-1-ene, 3,6-dimethylhept-1-ene, 2,6-dimethylhept-2-ene, 2,3-dimethylhept-2-ene, 3,5-dimethylhept-2-ene, 4,5-dimethylhept-2-ene, 4,6-dimethylhept-2-ene, 4-ethylhept-3-ene, 2,6-dimethylhept-3-ene, 4,6-dimethylhept-3-ene, 2,5-dimethylhept-4-ene, oct-1-ene, 2-methyloct-1-ene, 3-methyloct-1-ene, 4-methyloct-1-ene, 5-methyloct-1-ene, 6-methyloct-1-ene, 7-methyloct-1-ene, oct-2-ene, 2-methyloct-2-ene, 3-methyloct-2-ene, 4-methyloct-2-ene, 5-methyloct-2-ene, 6-methyloct-2-ene, 7-methyloct-2-ene, oct-3-ene, 2-methyloct-3-ene, 3-methyloct-3-ene, 4-methyloct-3-ene, 5-methyloct-3-ene, 6-methyloct-3-ene, 7-methyloct-3-ene, oct-4-ene, 2-methyloct-4-ene, 3-methyloct-4-ene, 4-methyloct-4-ene, 5-methyloct-4-ene, 6-methyloct-4-ene, 7-methyloct-4-ene, 7,7-dimethyloct-1-ene, 3,3-dimethyloct-1-ene, 4,7-dimethyloct-1-ene, 2,7-dimethyloct-2-ene, 2,3-dimethyloct-2-ene, 3,6-dimethyloct-2-ene, 4,5-dimethyloct-2-ene, 4,6-dimethyloct-2-ene, 4,7-dimethyloct-2-ene, 4-ethyloct-3-ene, 2,7-dimethyloct-3-ene, 4,7-dimethyloct-3-ene, 2,5-dimethyloct-4-ene, non-1-ene, 2-methylnon-1-ene, 3-methylnon-1-ene, 4-methylnon-1-ene, 5-methylnon-1-ene, 6-methylnon-1-ene, 7-methylnon-1-ene, 8-methylnon-1-ene, non-2-ene, 2-methylnon-2-ene, 3-methylnon-2-ene, 4-methylnon-2-ene, 5-methylnon-2-ene, 6-methylnon-2-ene, 7-methylnon-2-ene, 8-methylnon-2-ene, non-3-ene, 2-methylnon-3-ene, 3-methylnon-3-ene, 4-methylnon-3-ene, 5-methylnon-3-ene, 6-methylnon-3-ene, 7-methylnon-3-ene, 8-methylnon-3-ene, non-4-ene, 2-methylnon-4-ene, 3-methylnon-4-ene, 4-methylnon-4-ene, 5-methylnon-4-ene, 6-methylnon-4-ene, 7-methylnon-4-ene, 8-methylnon-4-ene, 4,8-dimethylnon-1-ene, 4,8-dimethylnon-4-ene, 2,8-dimethylnon-4-ene, dec-1-ene, 2-methyldec-1-ene, 3-methyldec-1-ene, 4-methyldec-1-ene, 5-methyldec-1-ene, 6-methyldec-1-ene, 7-methyldec-1-ene, 8-methyldec-1-ene, 9-methyldec-1-ene, dec-2-ene, 2-methyldec-2-ene, 3-methyldec-2-ene, 4-methyldec-2-ene, 5-methyldec-2-ene, 6-methyldec-2-ene, 7-methyldec-2-ene, 8-methyldec-2-ene, 9-methyldec-2-ene, dec-3-ene, 2-methyldec-3-ene, 3-methyldec-3-ene, 4-methyldec-3-ene, 5-methyldec-3-ene, 6-methyldec-3-ene, 7-methyldec-3-ene, 8-methyldec-3-ene, 9-methyldec-3-ene, dec-4-ene, 2-methyldec-4-ene, 3-methyldec-4-ene, 4-methyldec-4-ene, 5-methyldec-4-ene, 6-methyldec-4-ene, 7-methyldec-4-ene, 8-methyldec-4-ene, 9-methyldec-4-ene, dec-5-ene, 2-methyldec-5-ene, 3-methyldec-5-ene, 4-methyldec-5-ene, 5-methyldec-5-ene, 6-methyldec-5-ene, 7-methyldec-5-ene, 8-methyldec-5-ene, 9-methyldec-5-ene, 2,4-dimethyldec-1-ene, 2,4-dimethyldec-2-ene, 4,8-dimethyldec-1-ene, undec-1-ene, 2-methylundec-1-ene, 3-methylundec-1-ene, 4-methylundec-1-ene, 5-methylundec-1-ene, 6-methylundec-1-ene, 7-methylundec-1-ene, 8-methylundec-1-ene, 9-methylundec-1-ene, 10-methylundec-1-ene, undec-2-ene, 2-methylundec-2-ene, 3-methylundec-2-ene, 4-methylundec-2-ene, 5-methylundec-2-ene, 6-methylundec-2-ene, 7-methylundec-2-ene, 8-methylundec-2-ene, 9-methylundec-2-ene, 10-methylundec-2-ene, undec-3-ene, 2-methylundec-3-ene, 3-methylundec-3-ene, 4-methylundec-3-ene, 5-methylundec-3-ene, 6-methylundec-3-ene, 7-methylundec-3-ene, 8-methylundec-3-ene, 9-methylundec-3-ene, 10-methylundec-3-ene, undec-4-ene, 2-methylundec-4-ene, 3-methylundec-4-ene, 4-methylundec-4-ene, 5-methylundec-4-ene, 6-methylundec-4-ene, 7-methylundec-4-ene, 8-methylundec-4-ene, 9-methylundec-4-ene, 10-methylundec-4-ene, undec-5-ene, 2-methylundec-5-ene, 3-methylundec-5-ene, 4-methylundec-5-ene, 5-methylundec-5-ene, 6-methylundec-5-ene, 7-methylundec-5-ene, 8-methylundec-5-ene, 9-methylundec-5-ene, 10-methylundec-5-ene, dodec-1-ene, dodec-2-ene, dodec-3-ene, dodec-4-ene, dodec-5-ene, dodec-6-ene, 4,8-dimethyldec-1-ene, 4-ethyldec-1-ene, 6-ethyldec-1-ene, 8-ethyldec-1-ene, 2,5,8-trimethylnon-1-ene, tridec-1-ene, tridec-2-ene, tridec-3-ene, tridec-4-ene, tridec-5-ene, tridec-6-ene, 2-methyldodec-1-ene, 11-methyldodec-1-ene, 2,5-dimethylundec-2-ene, 6,10-dimethylundec-1-ene, tetradec-1-ene, tetradec-2-ene, tetradec-3-ene, tetradec-4-ene, tetradec-5-ene, tetradec-6-ene, tetradec-7-ene, 2-methyltridec-1-ene, 2-ethyldodec-1-ene, 2,6,10-trimethylundec-1-ene, 2,6-dimethyldodec-2-ene, 11-methyltridec-1-ene, 9-methyltridec-1-ene, 7-methyltridec-1-ene, 8-ethyldodec-1-ene, 6-ethyldodec-1-ene, 4-ethyldodec-1-ene, 6-butyldec-1-ene, pentadec-1-ene, pentadec-2-ene, pentadec-3-ene, pentadec-4-ene, pentadec-5-ene, pentadec-6-ene, pentadec-7-ene, 2-methyltetradec-1-ene, 3,7,11-trimethyldodec-1-ene, 2,6,10-trimethyldodec-1-ene, hexadec-1-ene, hexadec-2-ene, hexadec-3-ene, hexadec-4-ene, hexadec-5-ene, hexadec-6-ene, hexadec-7-ene, hexadec-8-ene, 2-methylpentadec-1-ene, 3,7,11-trimethyltridec-1-ene, 4,8,12-trimethyltridec-1-ene, 11-methylpentadec-1-ene, 13-methylpentadec-1-ene, 7-methylpentadec-1-ene, 9-methylpentadec-1-ene, 12-ethyltetradec-1-ene, 8-ethyltetradec-1-ene, 4-ethyltetradec-1-ene, 8-butyldodec-1-ene, 6-butyldodec-1-ene, heptadec-1-ene, heptadec-2-ene, heptadec-3-ene, heptadec-4-ene, heptadec-5-ene, heptadec-6-ene, heptadec-7-ene, heptadec-8-ene, 2-methylhexadec-1-ene, 4,8,12-trimethyltetradec-1-ene, octadec-1-ene, octadec-2-ene, octadec-3-ene, octadec-4-ene, octadec-5-ene, octadec-6-ene, octadec-7-ene, octadec-8-ene, octadec-9-ene, 2-methylheptadec-1-ene, 13-methylheptadec-1-ene, 10-butyltetradec-1-ene, 6-butyltetradec-1-ene, 8-butyltetradec-1-ene, 10-ethylhexadec-1-ene, nonadec-1-ene, nonadec-2-ene, 1-methyloctadec-1-ene, 7,11,15-trimethyl-hexadec-1-ene, eicos-1-ene, eicos-2-ene, 2,6,10,14-tetramethylhexadec-2-ene, 3,7,11,15-tetramethylhexadec-2-ene, 2,7,11,15-tetramethylhexadec-1-ene, docos-1-ene, docos-2-ene, docos-7-ene, 4,9,13,17-tetramethyloctadec-1-ene, tetracos-1-ene, tetracos-2-ene, tetracos-9-ene, hexacos-1-ene, hexacos-2-ene, hexacos-9-ene, triacont-1-ene, dotriacont-1-ene or tritriacont-1-ene, and also the cyclic alkenes cyclopentene, 2-methylcyclopent-1-ene, 3-methylcyclopent-1-ene, 4-methylcyclopent-1-ene, 3-butylcyclopent-1-ene, vinylcyclopentane, cyclohexene, 2-methylcyclohex-1-ene, 3-methylcyclohex-1-ene, 4-methylcyclohex-1-ene, 1,4-dimethylcyclohex-1-ene, 3,3,5-trimethylcyclohex-1-ene, 4-cyclopentylcyclohex-1-ene, vinylcyclohexane, cycloheptene, 1,2-dimethylcyclohept-1-ene, cyclooctene, 2-methylcyclooct-1-ene, 3-methylcyclooct-1-ene, 4-methylcyclooct-1-ene, 5-methylcyclooct-1-ene, cyclononene, cyclodecene, cycloundecene, cyclododecene, bicyclo[2.2.1]hept-2-ene, 5-ethyl-bicyclo[2.2.1]hept-2-ene, 2-methylbicyclo[2.2.2]oct-2-ene, bicyclo[3.3.1]non-2-ene or bicyclo[3.2.2]non-6-ene. It will be appreciated that mixtures of aforementioned monomers A can also be used for preparing the polymers A.

Preference is given to using the 1-alkenes, examples being propene, 2-methylpropene, but-1-ene, pent-1-ene, hex-1-ene, hept-1-ene, oct-1-ene, non-1-ene, dec-1-ene, undec-1-ene, dodec-1-ene, 2,4,4-trimethylpent-1-ene, 2,4-dimethylhex-1-ene, 6,6-dimethylhept-1-ene, 2-methyloct-1-ene, tridec-1-ene, tetradec-1-ene, hexadec-1-ene, heptadec-1-ene, octadec-1-ene, nonadec-1-ene, eicos-1-ene, docos-1-ene, tetracos-1-ene, 2,6-dimethyldodec-1-ene, 6-butyldec-1-ene, 4,8,12-trimethyldec-1-ene or 2-methylheptadec-1-ene. Advantageously, at least one monomer A1 used is an alkene having 6 to 18 carbon atoms, preferably a 1-alkene having 8 to 12 carbon atoms. Preference is given more particularly to using oct-1-ene, non-1-ene, dec-1-ene, undec-1-ene and/or dodec-1-ene, with oct-1-ene and/or dec-1-ene being particularly preferred.

Polymer A comprises in copolymerized form 0.1% to 40%, preferably 1% to 25%, and with more particular preference 4% to 16% by weight of monomers A1.

Monomers A2 contemplated are ethylenically unsaturated monocarboxylic acids, more particularly α,β-monoethylenically unsaturated monocarboxylic acids, of 3 to 6 carbon atoms, and also their water-soluble salts, more particularly their alkali metal salts or ammonium salts, such as, for example, acrylic acid, methacrylic acid, ethylacrylic acid, allylacetic acid, crotonic acid and/or vinylacetic acid, and also the ammonium, sodium or potassium salts of the aforementioned acids. Particular preference is given to acrylic acid and/or methacrylic acid, with acrylic acid being more particularly preferred.

The amount of monomers A2 in the polymer A is 40% to 99.9%, preferably 50% to 89%, and with more particular preference 55% to 70% by weight, in copolymerized form.

Monomers A3 contemplated are ethylenically unsaturated dicarboxylic acids, more particularly α,β-monoethylenically unsaturated dicarboxylic acids, of 4 to 12 carbon atoms, and also their water-soluble salts, more particularly their alkali metal salts or ammonium salts, and/or the ethylenically unsaturated dicarboxylic acid monoalkyl esters that are obtainable from the ethylenically unsaturated dicarboxylic acids of 4 to 12 carbon atoms, more particularly their C₁ to C₆ monoalkyl esters, examples being their monomethyl, monoethyl, monopropyl, monoisopropyl, monobutyl, monopentyl or monohexyl esters and also the correspondingly obtainable dicarboxylic anhydrides, such as, for example, maleic acid, fumaric acid, itaconic acid, methylmaleic acid, 1,2,3,6-tetrahydrophthalic acid, and the ammonium, sodium or potassium salts of the aforementioned acids, monomethyl, monoethyl, and monopropyl maleate, fumarate, itaconate, methylmaleate, and 1,2,3,6-tetrahydrophthalate, maleic anhydride, itaconic anhydride, methylmaleic anhydride or 1,2,3,6-tetrahydrophthalic anhydride. Particular preference is given to maleic acid, itaconic acid, methylmaleic acid, 1,2,3,6-tetrahydrophthalic acid, maleic anhydride, itaconic anhydride, methylmaleic anhydride, and/or 1,2,3,6-tetrahydrophthalic anhydride, with maleic anhydride being more particularly preferred.

The amount of monomers A3 in polymer A is 0% to 50%, preferably 10% to 40%, and with more particular preference 20% to 35% by weight, in copolymerized form.

Monomers A4 contemplated are all those ethylenically unsaturated compounds which differ from but are easily copolymerizable free-radically with the monomers A1 to A3, such as, for example, vinylaromatic monomers, such as styrene, α-methylstyrene, o-chlorostyrene or vinyltoluenes, vinyl halides, such as vinyl chloride or vinylidene chloride, esters of vinyl alcohol and monocarboxylic acids having 1 to 18 C atoms, such as vinyl acetate, vinyl propionate, vinyl n-butyrate, vinyl laurate, and vinyl stearate, esters of α,β-monoethylenically unsaturated monocarboxylic and dicarboxylic acids preferably of 3 to 6 C atoms, such as, more particularly, acrylic acid, methacrylic acid, maleic acid, fumaric acid, and itaconic acid, with alkanols having generally 1 to 12, preferably 1 to 8, and more particularly 1 to 4 C atoms, such as, in particular, methyl, ethyl, n-butyl, isobutyl, pentyl, hexyl, heptyl, octyl, nonyl, decyl and 2-ethylhexyl acrylate and methacrylate, dimethyl or di-n-butyl fumarate and maleate, nitriles of α,β-monoethylenically unsaturated carboxylic acids, such as acrylonitrile, methacrylonitrile, fumarodinitrile, maleodinitrile, and also C₄₋₈ conjugated dienes, such as 1,3-butadiene (butadiene) and isoprene. The stated monomers generally form the principal monomers, which, based on the total amount of monomers A4, account for a fraction of ≧50%, preferably ≧80%, and with more particular preference ≧90% by weight, or even form the total amount of the monomers A4. As a general rule these monomers are of only moderate to low solubility in water under S.T.P. [20° C., 1 atm (absolute)].

Monomers A4 which have a heightened water-solubility under the above-stated conditions are those which comprise either at least one sulfonic acid group and/or its corresponding anion, or at least one amino, amido, ureido or N-heterocyclic group and/or the ammonium derivatives thereof that are alkylated or protonated on the nitrogen. Mention may be made exemplarily of acrylamide and methacrylamide, and also vinylsulfonic acid, 2-acrylamido-2-methylpropanesulfonic acid, styrenesulfonic acid, and their water-soluble salts, and also N-vinylpyrrolidone, 2-vinylpyridine, 4-vinylpyridine, 2-vinylimidazole, 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazoline-2-onyl)ethyl methacrylate. Normally the aforementioned water-soluble monomers A4 are used only as modifying monomers, in amounts of ≦10%, preferably ≦5%, and with more particular preference ≦3% by weight, based in each case on the total amount of monomers A4. With more particular preference, however, no such water-soluble monomers A4 at all are used in preparing the polymer A.

Monomers A4 which typically enhance the internal strength of the films formed from a polymer matrix normally contain at least two nonconjugated ethylenically unsaturated double bonds. Examples of such monomers are monomers containing two vinyl radicals, monomers containing two vinylidene radicals, and monomers containing two alkenyl radicals. Particularly advantageous in this context are the diesters of dihydric alcohols with α,β-monoethylenically unsaturated monocarboxylic acids, among which acrylic acid and methacrylic acid are preferred. Examples of such monomers containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Frequently the aforementioned crosslinking monomers A4 are used in amounts of ≦10% by weight, but preferably in amounts of ≦3% by weight, based in each case on the total amount of monomers A4. With more particular preference, however, no such crosslinking monomers A4 at all are used.

For preparing the polymer A it is advantageous to use as monomers A4 those monomers or monomer mixtures which comprise
50% to 100% by weight of esters of acrylic and/or methacrylic acid with alkanols containing 1 to 12 carbon atoms, or
50% to 100% by weight of styrene and/or butadiene, or
50% to 100% by weight of vinyl chloride and/or vinylidene chloride, or
50% to 100% by weight of vinyl acetate and/or vinyl propionate.

Polymer A comprises in copolymerized form 0% to 30% by weight, preferably 0% to 15% by weight, and with more particular preference no monomers A4 at all.

The preparation of the polymer A per se is uncritical and is familiar in principle to the skilled worker. It is accomplished essentially by free-radically initiated polymerization of the monomers A1 to A4. This free-radical polymerization of the monomers A1 to A4 may take place in principle in bulk (bulk polymerization), in an organic solvent (solution polymerization) or in emulsified form in an aqueous medium (aqueous emulsion or suspension polymerization). The preparation of the polymer A is accomplished preferably by free-radically initiated solution polymerization in—for example—water or an organic solvent (see, for example, A. Echte, Handbuch der Technischen Polymerchemie, chapter 6, VCH, Weinheim, 1993 or B. Vollmert, Grundriss der Makromolekularen Chemie, volume 1, E. Vollmert Verlag, Karlsruhe, 1988).

In preparing the polymers A it is possible to include in each case either a portion or the total amount of the monomers A1 to A4 in the initial charge to the polymerization vessel. It is also possible, however, in each case to meter in the total amount or the respective remainder, as the case may be, of the monomers A1 to A4 during the polymerization reaction. The total amounts or the remainders, as the case may be, of monomers A1 to A4 may in that case be metered discontinuously, in one or more portions, or continuously, with constant or changing volume flows, into the polymerization vessel. Frequently at least a portion of the monomers A1 and/or A3 and, advantageously, monomer A3 exclusively, in the polymerization medium, is included in the initial charge before the polymerization reaction is initiated.

The free-radically initiated solution polymerization of the monomers A1 to A4 takes place preferably in a protic or an aprotic organic solvent, with aprotic solvents being more particularly preferred. Suitable aprotic organic solvents include all organic solvents which under polymerization conditions comprise no ionizable proton in the molecule or have a pKa which is greater than that of water. Examples of such solvents are aromatic hydrocarbons, such as toluene, o-, m-, and p-xylene, and isomer mixtures, and also ethylbenzene, linear or cyclic aliphatic hydrocarbons, such as pentane, hexane, heptane, octane, nonane, dodecane, cyclohexane, cyclooctane, methylcyclohexane, and also mixtures of the stated hydrocarbons, and gasoline fractions which comprise no polymerizable monomers, or aliphatic or aromatic halogenated hydrocarbons, such as chloroform, carbon tetrachloride, hexachloroethane, dichloroethane, tetrachloroethane, chlorobenzene, and also liquid C₁ and C₂ hydrofluorochlorocarbons, aliphatic C₂ to C₅ nitriles, such as acetonitrile, propionitrile, butyronitrile or valeronitrile, linear or cyclic aliphatic C₃ to C₇ ketones, such as acetone, methyl ethyl ketone, methyl isobutyl ketone, 2- and 3-hexanone, 2-, 3-, and 4-heptanone, cyclopentanone, cyclohexanone, linear or cyclic aliphatic ethers, such as diisopropyl ether, 1,3- or 1,4-dioxane, tetrahydrofuran or ethylene glycol dimethyl ether, carbonates, such as diethyl carbonate, and also esters of aliphatic C₁ to C₅carboxylic acids or aromatic carboxylic acids with aliphatic C₁ to C₅ alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, n-butyl butyrate, isobutyl butyrate, tert-butyl butyrate, amyl butyrate, methyl valerate, ethyl valerate, n-propyl valerate, isopropyl valerate, n-butyl valerate, isobutyl valerate, tert-butyl valerate, amyl valerate, methyl benzoate or ethyl benzoate, and also lactones, such as butyrolactone, valerolactone or caprolactone.

Preference, however, is given to selecting those aprotic organic solvents in which the particular free-radical initiators used dissolve well. More particularly, use is made of those aprotic organic solvents in which not only the free-radical initiators but also the polymers A dissolve well. More particular preference is given to selecting those aprotic organic solvents which additionally can be separated in a simple way from the resulting polymer A solution, such as, for example, by distillation, inert-gas stripping and/or steam distillation. Preferred examples of such are esters of aliphatic C₁ to C₅ carboxylic acids or aromatic carboxylic acids with aliphatic C₁ to C₅ alcohols, such as ethyl formate, n-propyl formate, isopropyl formate, n-butyl formate, isobutyl formate, tert-butyl formate, amyl formate, methyl acetate, ethyl acetate, n-propyl acetate, isopropyl acetate, n-butyl acetate, isobutyl acetate, tert-butyl acetate, amyl acetate, methyl propionate, ethyl propionate, n-propyl propionate, isopropyl propionate, n-butyl propionate, isobutyl propionate, tert-butyl propionate, amyl propionate, methyl butyrate, ethyl butyrate, n-propyl butyrate, isopropyl butyrate, linear or cyclic aliphatic ethers, such as diisopropyl ether, 1,3- or 1,4-dioxane, tetrahydrofuran or ethylene glycol dimethyl ether, methyl glycol acetate, diethyl carbonate, linear or cyclic aliphatic C₃ to C₇ ketones, such as acetone, methyl ethyl ketone, methyl isobutyl ketone, 2- or 3-hexanone, 2-, 3- or 4-heptanone, cyclopentanone, or cyclohexanone. Particularly preferred solvents are the abovementioned esters of aliphatic C₁ to C₅ carboxylic acids or aromatic carboxylic acids with aliphatic C₁ to C₅ alcohols, but more particularly ethyl acetate and ethyl butyrate, and also C₄ to C₆ ketones, more particularly methyl ethyl ketone. It is advantageous if the solvent has a boiling point under atmospheric pressure (1 atm=1.013 bar absolute) ≦140° C., frequently ≦125° C., and more particularly ≦100° C., or forms a low-boiling azeotropic water/solvent mixture with water. It will be appreciated that a mixture of two or more solvents can also be used.

The amount of solvent in the preparation of the polymer A is 40 to 9900 parts, preferably 70 to 400 parts, and with more particular preference 80 to 200 parts by weight, based in each case on 100 parts by weight of total monomers A.

In preparing the polymer A it is possible to include either a portion or the entirety of solvent in the initial charge to the polymerization vessel. It is, however, also possible to meter in the entirety or any remainder of solvent during the polymerization reaction. In that case the entirety or, as the case may be, the remainder of solvent can be metered into the polymerization vessel discontinuously, in one or more portions, or continuously, with constant or changing volume flows. Advantageously a portion of the solvent as polymerization medium is included in the initial charge to the polymerization vessel before the polymerization reaction is initiated, and the remainder is metered in together with the monomers A1 to A4 and the free-radical initiator during the polymerization reaction.

The free-radical polymerization of the monomers A1 to A4 is initiated and maintained by means of what are known as free-radical initiators. Free-radical initiators (initiators which form free radicals) that are suitable are preferably all those free-radical-forming initiators which have a half-life at polymerization temperature of ≦3 hours, more particularly ≦1 hour, and advantageously ≦30 minutes.

Where the polymerization of the monomers A1 to A4 is carried out in an aqueous medium, use is made of what are known as water-soluble free-radical initiators, which the skilled worker typically uses in the case of free-radically initiated aqueous emulsion polymerization. If, on the other hand, the polymerization of the monomers is carried out in an organic solvent, then what are known as oil-soluble free-radical initiators are used, which the skilled worker typically uses in the case of free-radically initiated solution polymerization.

Examples that may be mentioned of oil-soluble free-radical initiators include dialkyl and diaryl peroxides, such as di-tert-amyl peroxide, dicumyl peroxide, bis(tert-butylperoxyisopropyl)benzene, 2,5-bis(tert-butylperoxy)-2,5-dimethylhexane, tert-butylcumene peroxide, 2,5-bis(tert-butylperoxy)-2,5-dimethyl-3-hexene, 1,1-bis(tert-butylperoxy)-3,3,5-trimethylcyclohexane, 1,1-bis(tert-butylperoxy)cyclohexane, 2,2-bis(tert-butylperoxy)butane or di-tert-butyl peroxide, aliphatic and aromatic peroxyesters, such as cumyl peroxyneodecanoate, 2,4,4-trimethylpentyl 2-peroxyneodecanoate, tert-amyl peroxyneodecanoate, tert-butyl peroxyneodecanoate, tert-amyl peroxypivalate, tert-butyl peroxypivalate, tert-amyl peroxy-2-ethylhexanoate, tert-butyl peroxy-2-ethylhexanoate, tert-butyl peroxydiethylacetate, 1,4-bis(tert-butylperoxy)cyclohexane, tert-butyl peroxyisobutanoate, tert-butyl peroxy-3,5,5-trimethylhexanoate, tert-butyl peroxyacetate, tert-amyl peroxybenzoate or tert-butyl peroxybenzoate, dialkanoyl and dibenzoyl peroxides, such as diisobutanoyl peroxide, bis(3,5,5-trimethylhexanoyl) peroxide, dilauroyl peroxide, didecanoyl peroxide, 2,5-bis(2-ethylhexanoylperoxy)-2,5-dimethylhexane or dibenzoyl peroxide, and also peroxycarbonates, such as bis(4-tert-butylcyclohexyl) peroxydicarbonate, bis(2-ethylhexyl) peroxydicarbonate, di-tert-butyl peroxydicarbonate, diacetyl peroxydicarbonate, dimyristyl peroxydicarbonate, tert-butyl peroxyisopropyl carbonate or tert-butyl peroxy-2-ethylhexyl carbonate. Examples of readily oil-soluble azo initiators used include 2,2′-azobis(isobutyronitrile), 2,2′-azobis(2,4-dimethyl-valeronitrile) or 4,4′-azobis(4-cyanopentanoic acid).

A preferred oil-soluble free-radical initiator used is a compound selected from the group comprising tert-butyl peroxy-2-ethylhexanoate (Trigonox® 21; Trigonox® brand name of Akzo Nobel), tert-amyl peroxy-2-ethylhexanoate (Trigonox® 121), tert-butyl peroxybenzoate (Trigonox® C), tert-amyl peroxybenzoate, tert-butyl peroxyacetate (Trigonox® F), tert-butyl peroxy-3,5,5-trimethylhexanoate (Trigonox® 42 S), tert-butyl peroxyisobutanoate, tert-butyl peroxydiethylacetate (Trigonox® 27), tert-butyl peroxypivalate (Trigonox® 25), tert-butyl peroxyisopropyl carbonate (Trigonox® BPIC), 2,5-dimethyl-2,5-di(tert-butylperoxy)hexane (Trigonox® 101), di-tert-butyl peroxide (Trigonox® B), cumyl hydroperoxide (Trigonox® K) and tert-butyl peroxy-2-ethylhexyl carbonate (Trigonox® 117). It will be appreciated that it is also possible to use mixtures of aforementioned oil-soluble free-radical initiators.

The amount of free-radical initiator used is generally 0.01% to 10%, preferably 0.1% to 8%, and with more particular preference 1% to 6% by weight, based in each case on the total amount of monomers A.

In preparing the polymer A it is possible to include either a portion or the entirety of free-radical initiator in the initial charge to the polymerization vessel. It is also possible, however, to meter in the entirety or any remainder of free-radical initiator during the polymerization reaction. The entirety or any remainder of free-radical initiator may in that case be metered into the polymerization vessel discontinuously, in one or more portions, or continuously, with constant or changing volume flows. With more particular advantage the free-radical initiator is metered during the polymerization reaction continuously, with constant volume flow—more particularly in the form of a solution of the free-radical initiator with the solvent used.

Polymer A advantageously has a weight-average molecular weight ≧1000 g/mol and ≦100 000 g/mol. It is advantageous if the weight-average molecular weight of polymer A is ≦50 000 g/mol or ≦40 000 g/mol. With more particular advantage polymer A has a weight-average molecular weight ≧3000 g/mol and ≦40 000 g/mol. With particular advantage the weight-average molecular weight is situated in the range ≧3000 and ≦25 000 g/mol. The setting of the weight-average molecular weight during the preparation of polymer A is familiar to the skilled worker and is advantageously accomplished by free-radically initiated aqueous solution polymerization in the presence of free-radical chain-transfer compounds, referred to as free-radical chain regulators. The determination of the weight-average molecular weight is also familiar to the skilled worker and is accomplished, for example, by means of gel permeation chromatography.

Examples of suitable free-radical chain regulators are organic compounds comprising sulfur in bonded form. They include, for example, mercapto compounds, such as mercaptoethanol, mercaptopropanol, mercaptobutanol, mercaptoacetic acid, mercaptopropionic acid, butyl mercaptan, and dodecyl mercaptan. Further free-radical chain regulators are familiar to the skilled worker. If the polymerization is carried out in the presence of free-radical chain regulators, it is common to use 0.01% to 10% and often 0.1% to 5% by weight, in each case based on the total amount of monomers A.

In accordance with the invention it is possible to include at least a portion of the free-radical chain regulator in the initial charge to the polymerization medium and to add any remainder to the polymerization medium after the free-radical polymerization reaction has been initiated, that addition taking place discontinuously in one portion, discontinuously in two or more portions, and also continuously with constant or changing volume flows. Frequently the total amount of the free-radical chain regulator is added continuously, together with the monomers A1 to A4, during the polymerization reaction.

By controlled variation of the nature and amount of the monomers A1 to A4 it is possible in accordance with the invention for the skilled worker to prepare polymers A which have a glass transition temperature or a melting point in the range from −60 to 270° C. Advantageously in accordance with the invention the glass transition temperature of the polymer A is ≧−20° C. and ≦110° C., and preferably ≧20° C. and ≦105° C.

The glass transition temperature, T_{g}, is the limiting value of the glass transition temperature to which said temperature tends with increasing molecular weight, according to G. Kanig (Kolloid-Zeitschrift & Zeitschrift für Polymere, vol. 190, p. 1, equation 1). The glass transition temperature or melting point is determined by the DSC method (differential scanning calorimetry, 20 K/min, midpoint measurement, DIN 53765).

According to Fox (T. G. Fox, Bull. Am. Phys. Soc. 1956 [Ser. II] 1, page 123, and in accordance with Ullmann's Encyclopadie der technischen Chemie, vol. 19, page 18, 4th edition, Verlag Chemie, Weinheim, 1980) the glass transition temperature of copolymers with no more than low degrees of crosslinking is given in good approximation by:

1/T_{g}=x¹/T_{g}¹+x²/T_{g}²+ . . . xⁿ/T_{g}n,

where x¹, x², . . . xⁿ are the mass fractions of the monomers 1, 2, . . . n and T_{g}¹, T_{g}², . . . T_{g}ⁿ are the glass transition temperatures of the polymers synthesized in each case only from one of the monomers 1, 2, . . . n, in degrees Kelvin. The T_{g} values for the homopolymers of the majority of monomers are known and are listed, for example, in Ullmann's Encyclopedia of Industrial Chemistry, 5th edition, vol. A21, page 169, VCH Weinheim, 1992; further sources of homopolymer glass transition temperatures include, for example, J. Brandrup, E. H. Immergut, Polymer Handbook, 1st ed., J. Wiley, New York 1966, 2nd ed. J. Wiley, New York 1975, and 3rd ed. J. Wiley, New York 1989).

Depending on the free-radical initiator used, the free-radically initiated polymerization takes place typically at temperatures in the range from 40 to 180° C., preferably from 50 to 150° C., and more particularly from 60 to 110° C. As soon as the temperature during the polymerization reaction is above the boiling point of the solvent and/or of one of the monomers A1 to A4, the polymerization is carried out advantageously under pressure (>1 atm absolute). The temperature and pressure conditions are familiar to the skilled worker or can be determined by him or her in a few routine experiments.

The polymers A can be prepared in the typical polymerization apparatus. Examples of those used for this purpose include glass flasks (laboratory) or stirred tanks (industrial scale) equipped with an anchor, blade, impeller, cross-arm, MIG or multistage pulsed counter-current stirrer. In the case more particularly of polymerization in the presence of only small amounts of solvent, it may also be advantageous to carry out the polymerization in typical one-screw of two-screw (co-rotating or counter-rotating) kneader reactors, such as those, for example, from the company List or Buss SMS.

Where polymer A is prepared in an organic solvent, at least some of the organic solvent, advantageously ≧50% or ≧90% by weight, and, with more particular advantage, all of the organic solvent, is generally then removed, and the polymer A is taken up in water, advantageously in deionized water. The corresponding methods are familiar to the skilled worker. Thus, for example, the switching of the solvent for water can be accomplished by distilling off at least some of the solvent, advantageously all of it, in one or more stages, at, for example, atmospheric pressure (1 atm absolute) or subatmospheric pressure (<1 atm absolute), and replacing it by water. Frequently it may be advantageous to remove the solvent from the solution by introducing steam and at the same time to replace it by water. This is more particularly the case when the organic solvent has good steam volatility.

The polymer A solutions used in accordance with the invention typically have polymer solids contents of ≧10% and ≦70%, frequently ≧20% and ≦65%, and often ≧40% and ≦60% by weight, based in each case on the corresponding polymer A solution.

The aqueous binder of the invention comprises as essential second component a polymer B obtainable by free-radical addition polymerization and comprising in copolymerized form 0.1% to 15% by weight of at least one ethylenically unsaturated compound containing at least one carboxyl, hydroxyalkyl, epoxy, methylol, silyl and/or oxazolinyl group [monomer B1] and 85% to 99.9% by weight of at least one other ethylenically unsaturated compound [monomer B2] which is copolymerizable with the monomer B1, the amounts of monomers B1 and B2 adding up to 100% by weight.

Suitable monomers B1 include ethylenically unsaturated C₃ to C₆ monocarboxylic or dicarboxylic acids, more particularly C₃ and C₄ monocarboxylic or dicarboxylic acids, such as, for example, acrylic acid, methacrylic acid, crotonic acid, fumaric acid, maleic acid, 2-methylmaleic acid and/or itaconic acid, their alkali metal salts or ammonium salts or their anhydrides, such as maleic anhydride, for example. As monomers B1 it is likewise possible for all ethylenically unsaturated monomers which comprise at least one hydroxyalkyl group to be used, such as, for example, hydroxyalkyl acrylates and methacrylates having C₂ to C₁₀ hydroxyalkyl groups, advantageously C₂ to C₄ hydroxyalkyl groups, such as, more particularly, 2-hydroxyethyl acrylate, 2-hydroxyethyl methacrylate, 2-hydroxypropyl acrylate, 2-hydroxypropyl methacrylate, 4-hydroxybutyl acrylate, 4-hydroxybutyl methacrylate, diethylene glycol monoacrylate or diethylene glycol monomethacrylate, and also hydroxyalkyl vinyl ethers of C₂ to C₁₀ hydroxyalkyl groups, advantageously C₂ to C₄ hydroxyalkyl groups, such as, for example, 2-hydroxyethyl vinyl ether, 3-hydroxypropyl vinyl ether, 2-hydroxypropyl vinyl ether or 4-hydroxybutyl vinyl ether. Also used as monomers B1 are ethylenically unsaturated compounds containing epoxy groups, such as, for example, glycidyl acrylate or glycidyl methacrylate, and ethylenically unsaturated compounds containing methylolamide groups, such as, for example, N-methylolacrylamide and/or N-methylolmethacrylamide. Likewise suitable as monomers B1 are all ethylenically unsaturated compounds which contain at least one oxazolinyl group, such as, for example, 2-isopropenyl-2-oxazoline, 5-(2-oxazolinyl)pentyl acrylate or 5-(2-oxazolinyl)pentyl methacrylate, or carry at least one silicon-containing functional group (silyl group), such as, for example, vinylalkoxysilanes, more particularly vinyltrimethoxysilane, vinyltriethoxysilane, vinyltriisopropoxysilane, vinyltriphenoxysilane, vinyltris(dimethylsiloxy)silane, vinyltris(2-methoxyethoxy)silane, vinyltris(3-methoxypropoxy)silane and/or vinyltris(trimethylsiloxy)silane, vinylalkoxycarbonylsilanes, more particularly vinyltrimethoxycarbonylsilane (vinyltriacetoxysilane), vinyltriethoxycarbonylsilane and/or vinyltriisopropoxycarbonylsilane, acryloyloxysilanes, such as, more particularly, 2-(acryloyloxyethoxy)trimethylsilane, acryloyloxymethyltrimethylsilane, (3-acryloyloxypropyl)dimethylmethoxysilane, (3-acryloyloxypropyl)methylbis(trimethylsiloxy)silane, (3-acryloyloxypropyl)methyldimethoxysilane, (3-acryloyloxypropyl)trimethoxysilane and/or (3-acryloyloxypropyl)tris(trimethylsiloxy)silane, or methacryloyloxysilanes, such as, more particularly, (3-methacryloyloxypropyl)trimethoxysilane, (3-methacryloyloxypropyl)triethoxysilane, (methacryloyloxymethyl)methyldiethoxysilane and/or (3-methacryloyloxypropyl)methyldiethyloxysilane.

The monomer B1 is preferably selected from the group comprising acrylic acid, methacrylic acid, crotonic acid, fumaric acid, maleic acid, maleic anhydride, methylmaleic acid, itaconic acid, 2-hydroxyethyl acrylate, 2-hydroxyethyl methacrylate, 2-hydroxypropyl acrylate, 2-hydroxypropyl methacrylate, 4-hydroxybutyl acrylate, diethylene glycol monoacrylate, 4-hydroxybutyl vinyl ether, glycidyl acrylate, glycidyl methacrylate, N-methylolacrylamide, N-methylolmethacrylamide, 2-isopropenyl-2-oxazoline, 5-(2-oxazolinyl)pentyl methacrylate, (3-methacryloyloxy-propyl)trimethoxysilane, vinyltriacetoxysilane, and vinyltriethoxysilane.

Polymer B comprises 0.1% to 15%, preferably 1% to 14%, and with more particular preference 4% to 12% by weight of monomers B1 in copolymerized form.

Suitable monomers B2 include ethylenically unsaturated monomers which in particular are free-radically copolymerizable in a simple way with the monomers B1, examples of said monomers B2 being ethylene, vinyl aromatic monomers, such as styrene, α-methylstyrene, o-chlorostyrene or vinyltoluenes, esters of vinyl alcohol and monocarboxylic acids containing 1 to 18 C atoms, such as vinyl acetate, vinyl propionate, vinyl n-butyrate, vinyl laurate and vinyl stearate, esters of α,β-monoethylenically unsaturated monocarboxylic and dicarboxylic acids containing preferably 3 to 6 C atoms, such as, more particularly, acrylic acid, methacrylic acid, maleic acid, fumaric acid, and itaconic acid, with alkanols containing generally 1 to 12, preferably 1 to 8, and more particularly 1 to 4 C atoms, such as, in particular, methyl, ethyl, n-butyl, isobutyl, and 2-ethylhexyl acrylate and methacrylate, dimethyl maleate or di-n-butyl maleate, nitriles of α,β-monoethylenically unsaturated carboxylic acids, such as acrylonitrile, and also C₄₋₈ conjugated dienes, such as 1,3-butadiene and isoprene. The stated monomers generally form the principal monomers, which, based on the total amount of the monomers B2, normally account for a fraction of ≧50%, ≧80% or ≧90% by weight. As a general rule these monomers are of only moderate to low solubility in water under S.T.P. [20° C., 1 atm (absolute)].

Further monomers B2 which typically enhance the internal strength of the films formed from the polymer matrix normally contain at least two nonconjugated ethylenically unsaturated double bonds. Examples of such monomers are monomers containing two vinyl radicals, monomers containing two vinylidene radicals, and monomers containing two alkenyl radicals. Particularly advantageous in this context are the diesters of dihydric alcohols with α,β-monoethylenically unsaturated monocarboxylic acids, among which acrylic acid and methacrylic acid are preferred. Examples of such monomers containing two nonconjugated ethylenically unsaturated double bonds are alkylene glycol diacrylates and dimethacrylates, such as ethylene glycol diacrylate, 1,2-propylene glycol diacrylate, 1,3-propylene glycol diacrylate, 1,3-butylene glycol diacrylate, 1,4-butylene glycol diacrylates, and ethylene glycol dimethacrylate, 1,2-propylene glycol dimethacrylate, 1,3-propylene glycol dimethacrylate, 1,3-butylene glycol dimethacrylate, and 1,4-butylene glycol dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate or triallyl isocyanurate. Normally the aforementioned crosslinking monomers B2 are used merely as modifying monomers in amounts of ≦5% by weight, often 0.1% to 3%, and frequently 0.5% to 2% by weight, based in each case on the total amount of monomers B2.

Besides these as monomers B2 it is additionally possible to use those ethylenically unsaturated monomers which comprise either at least one acid group (apart from the carboxyl group) and/or its corresponding anion (monomers B2S), or those ethylenically unsaturated monomers which comprise at least one amino, amido, ureido or N-heterocyclic group (apart from the oxazolinyl group) and/or the ammonium derivatives thereof that are alkylated or protonated on the nitrogen (monomers B2A). Normally the aforementioned monomers B2S or B2A are used merely as modifying monomers in amounts of ≦5%, often ≦3%, and frequently ≦1% by weight, based in each case on the total amount of monomers B2. Preferably, however, no such monomers B2S or B2A are used at all.

As monomers B2S, ethylenically unsaturated monomers having at least one acid group are used. This acid group may be, for example, a sulfonic, sulfuric, phosphoric and/or phosphonic acid group. Examples of such monomers B2S are 4-styrenesulfonic acid, 2-methacryloyloxyethylsulfonic acid, vinylsulfonic acid, and vinylphosphonic acid, and also phosphoric monoesters of n-hydroxyalkyl acrylates and n-hydroxyalkyl methacrylates, such as, for example, phosphoric monoesters of hydroxyethyl acrylate, n-hydroxypropyl acrylate, n-hydroxybutyl acrylate, and hydroxyethyl methacrylate, n-hydroxypropyl methacrylate or n-hydroxybutyl methacrylate. It is of course also possible, however, to use the ammonium salts and alkali metal salts of the aforementioned ethylenically unsaturated monomers containing at least one acid group. An especially preferred alkali metal is sodium or potassium. Examples thereof are the ammonium, sodium, and potassium salts of 4-styrenesulfonic acid, 2-methacryloyloxyethylsulfonic acid, vinylsulfonic acid, and vinylphosphonic acid, and also the mono- and di-ammonium, -sodium, and potassium salts of the phosphoric monoesters of hydroxyethyl acrylate, n-hydroxypropyl acrylate, n-hydroxybutyl acrylate, and hydroxyethyl methacrylate, n-hydroxypropyl methacrylate or n-hydroxybutyl methacrylate.

Monomers B2A used are ethylenically unsaturated monomers which comprise at least one amino, amido, ureido or N-heterocyclic group and/or the ammonium derivatives thereof that are alkylated or protonated on the nitrogen.

Examples of monomers B2A which comprise at least one amino group are 2-aminoethyl acrylate, 2-aminoethyl methacrylate, 3-aminopropyl acrylate, 3-aminopropyl methacrylate, 4-amino-n-butyl acrylate, 4-amino-n-butyl methacrylate, 2-(N-methylamino)ethyl acrylate, 2-(N-methylamino)ethyl methacrylate, 2-(N-ethylamino)ethyl acrylate, 2-(N-ethylamino)ethyl methacrylate, 2-(N-n-propylamino)ethyl acrylate, 2-(N-n-propylamino)ethyl methacrylate, 2-(N-isopropylamino)ethyl acrylate, 2-(N-isopropylamino)ethyl methacrylate, 2-(N-tert-butylamino)ethyl acrylate, 2-(N-tert-butylamino)ethyl methacrylate (available commercially, for example, as Norsocryl® TBAEMA from Elf Atochem), 2-(N,N-dimethylamino)ethyl acrylate (available commercially, for example, as Norsocryl® ADAME from Elf Atochem), 2-(N,N-dimethylamino)ethyl methacrylate (available commercially, for example, as Norsocryl® MADAME from Elf Atochem), 2-(N,N-diethylamino)ethyl acrylate, 2-(N,N-diethylamino)ethyl methacrylate, 2-(N,N-di-n-propylamino)ethyl acrylate, 2-(N,N-di-n-propylamino)ethyl methacrylate, 2-(N,N-diisopropylamino)ethyl acrylate, 2-(N,N-diisopropylamino)ethyl methacrylate, 3-(N-methylamino)propyl acrylate, 3-(N-methylamino)propyl methacrylate, 3-(N-ethylamino)propyl acrylate, 3-(N-ethylamino)propyl methacrylate, 3-(N-n-propylamino)propyl acrylate, 3-(N-n-propylamino)propyl methacrylate, 3-(N-isopropylamino)propyl acrylate, 3-(N-isopropylamino)propyl methacrylate, 3-(N-tert-butylamino)propyl acrylate, 3-(N-tert-butylamino)propyl methacrylate, 3-(N,N-dimethylamino)propyl acrylate, 3-(N,N-dimethylamino)propyl methacrylate, 3-(N,N-diethylamino)propyl acrylate, 3-(N,N-diethylamino)propyl methacrylate, 3-(N,N-di-n-propylamino)propyl acrylate, 3-(N,N-di-n-propylamino)propyl methacrylate, 3-(N,N-diisopropylamino)propyl acrylate, and 3-(N,N-diisopropylamino)propyl methacrylate.

Examples of monomers B2A which comprise at least one amido group are acrylamide, methacrylamide, N-methylacrylamide, N-methylmethacrylamide, N-ethylacrylamide, N-ethylmethacrylamide, N-n-propylacrylamide, N-n-propylmethacrylamide, N-isopropylacrylamide, N-isopropylmethacrylamide, N-tert-butylacrylamide, N-tert-butylmethacrylamide, N,N-dimethylacrylamide, N,N-dimethylmethacrylamide, N,N-diethylacrylamide, N,N-diethylmethacrylamide, N,N-di-n-propylacrylamide, N,N-di-n-propylmethacrylamide, N,N-diisopropylacrylamide, N,N-diisopropylmethacrylamide, N,N-di-n-butylacrylamide, N,N-di-n-butylmethacrylamide, N-(3-N′,N′-dimethylaminopropyl)methacrylamide, diacetoneacrylamide, N,N′-methylenebisacrylamide, N-(diphenylmethyl)acrylamide, N-cyclohexylacrylamide, and also N-vinylpyrrolidone and N-vinylcaprolactam.

Examples of monomers B2A which comprise at least one ureido group are N,N′-divinylethyleneurea and 2-(1-imidazolin-2-onyl)ethyl methacrylate (available commercially, for example, as Norsocryl® 100 from Elf Atochem).

Examples of monomers B2A which comprise at least one N-heterocyclic group are 2-vinylpyridine, 4-vinylpyridine, 1-vinylimidazole, 2-vinylimidazole, and N-vinylcarbazole.

Depending on the pH of the aqueous reaction medium it is possible for some or all of the aforementioned nitrogen-containing monomers B2A to be present in the quaternary ammonium form with protonation on the nitrogen.

It will be appreciated that mixtures of the aforementioned ethylenically unsaturated monomers B2S or B2A can also be used.

Preferred monomers B2 are styrene, vinyl acetate, acrylonitrile, 1,3-butadiene, methyl methacrylate, ethyl acrylate, n-butyl acrylate, n-butyl methacrylate and/or 2-ethylhexyl acrylate, with more particular preference being given to styrene, methyl methacrylate, n-butyl acrylate and/or 2-ethylhexyl acrylate.

Polymer B comprises 85% to 99.9%, preferably 86% to 99%, and with more particular preference 88% to 96% by weight of monomers B2 in copolymerized form.

In one preferred embodiment the polymer B is composed in copolymerized form of:

40% to 56% by weight of styrene,
40% to 56% by weight of n-butyl acrylate,
2% to 7% by weight of 2-hydroxyethyl acrylate and,
2% to 7% by weight of glycidyl methacrylate.

The polymers B which can be used in accordance with the invention advantageously have a glass transition temperature T_{g}≧−40 and ≦110° C., preferably ≧0 and ≦105° C., and with more particular preference ≧0 and ≦100° C.

The preparation of the polymer B per se is not critical and is familiar in principle to the skilled worker. It is accomplished essentially by free-radically initiated polymerization of the monomers B1 and B2. This free-radical polymerization of the monomers B1 and B2 may be accomplished in principle in bulk (bulk polymerization), in an organic solvent (solution polymerization) or in emulsified form in an aqueous medium (aqueous emulsion or suspension polymerization). Polymer B is prepared preferably by free-radically initiated emulsion polymerization of the monomers B1 and B2 in an aqueous medium.

The implementation of free-radically initiated emulsion polymerizations of ethylenically unsaturated monomers in an aqueous medium has been described many times before and is therefore well known to the skilled worker [in this regard cf. Emulsion polymerization in Encyclopedia of Polymer Science and Engineering, Vol. 8, pages 659 ff. (1987); D. C. Blackley, in High Polymer Latices, Vol. 1, pages 35 ff. (1966); H. Warson, The Applications of Synthetic Resin Emulsions, Chapter 5, pages 246 ff. (1972); D. Diederich, Chemie in unserer Zeit 24, pages 135 to 142 (1990); Emulsion Polymerization, Interscience Publishers, New York (1965); DE-A 40 03 422 and Dispersionen synthetischer Hochpolymerer, F. Hölscher, Springer-Verlag, Berlin (1969)]. The free-radically initiated aqueous emulsion polymerization reactions usually take place by the ethylenically unsaturated monomers being dispersed in the aqueous medium in the form of monomer droplets, with the accompanying use of dispersing assistants, and being polymerized by means of a water-soluble free-radical polymerization initiator. The preparation of the polymer B differs from this general procedure only in the use of the aforementioned specific monomers B1 and B2.

In preparing the polymers B it is possible to include in each case either a portion or the total amount of the monomers B1 and B2 in the initial charge to the polymerization vessel. It is also possible, however, in each case to meter in the total amount or the respective remainder, as the case may be, of the monomers B1 and B2 during the polymerization reaction. The total amounts or the remainders, as the case may be, of monomers B1 and B2 may in that case be metered discontinuously, in one or more portions, or continuously, with constant or changing volume flows, into the polymerization vessel. With advantage the monomers B1 and B2 are used jointly as a monomer mixture, more particularly in the form of an aqueous monomer emulsion.

The free-radically initiated polymerization reaction in the preparation of the polymer B used in accordance with the invention is triggered by means of a free-radical initiator which is familiar to the skilled worker for aqueous emulsion polymerization. The initiators in question may in principle be peroxides and azo compounds. It will be appreciated that redox initiator systems are suitable as well. As peroxides it is possible in principle to use inorganic peroxides, such as hydrogen peroxide or peroxodisulfates, such as the mono- or di-alkali metal orammonium salts of peroxodisulfuric acid, such as, for example, its mono- and di-sodium, -potassium or ammonium salts, or organic peroxides, such as alkyl hydroperoxides, examples being tert-butyl, p-menthyl, and cumyl hydroperoxide, and also dialkyl or diaryl peroxides, such as di-tert-butyl peroxide or dicumyl peroxide. Azo compounds used are mainly 2,2′-azobis(isobutyronitrile), 2,2′-azobis(2,4-dimethylvaleronitrile), and 2,2′-azobis(amidinopropyl) dihydrochloride (AIBA, corresponding to V-50 from Wako Chemicals). Suitable oxidizing agents for redox initiator systems are essentially the peroxides stated above. As corresponding reducing agents it is possible to use compounds of sulfur with a low oxidation state, such as alkali metal sulfites, examples being potassium and/or sodium sulfite, alkali metal hydrogen sulfites, examples being potassium and/or sodium hydrogen sulfite, alkali metal metabisulfites, examples being potassium and/or sodium metabisulfite, formaldehyde-sulfoxylates, examples being potassium and/or sodium formaldehyde-sulfoxylate, alkali metal salts, especially potassium and/or sodium salts, aliphatic sulfinic acids, and alkali metal hydrogensulfides, such as, for example, potassium and/or sodium hydrogensulfide, salts of polyvalent metals, such as iron(II) sulfate, iron(II) ammonium sulfate, iron(II) phosphate, enediols, such as dihydroxymaleic acid, benzoin and/or ascorbic acid, and also reducing saccharides, such as sorbose, glucose, fructose and/or dihydroxyacetone. In general the amount of the free-radical initiator that is used, based on the total amount of monomers B, is 0.01% to 5%, preferably 0.1% to 3%, and with more particular preference 0.2% to 1.5% by weight.

This polymerization reaction takes place under temperature and pressure conditions under which the free-radically initiated aqueous emulsion polymerization proceeds at a sufficient polymerization rate; it is dependent in particular on the free-radical initiator used. Advantageously the nature and amount of the free-radical initiator, the polymerization temperature, and the polymerization pressure are selected such that the free-radical initiator has a half life ≦3 hours, with particular advantage ≦1 hour, and with very particular advantage ≦30 minutes.

In accordance with the invention it is possible to include either a portion or the entirety of free-radical initiator in the initial charge to the polymerization vessel. It is also possible, however, to meter in the entirety or any remainder of free-radical initiator during the polymerization reaction. The entirety or any remainder of free-radical initiator may in that case be metered into the polymerization vessel discontinuously, in one or more portions, or continuously, with constant or changing volume flows. With more particular advantage the free-radical initiator is metered during the polymerization reaction continuously, with constant volume flow—more particularly in the form of an aqueous solution of the free-radical initiator.

Depending on the free-radical initiator chosen, a suitable reaction temperature for the free-radical initiated aqueous emulsion polymerization is the entire range from 0 to 170° C. Generally speaking, temperatures of 50 to 120° C. are employed, more particularly 60 to 110° C., and advantageously 70 to 100° C. The free-radical initiated polymerization reaction of the invention can be carried out at a pressure lower than, equal to or greater than 1 atm (1.013 bar absolute), and so the polymerization temperature may exceed 100° C. and may be up to 170° C. Volatile monomers, such as ethylene, butadiene or vinyl chloride, for example, are preferably polymerized at an increased pressure. In this case the pressure may adopt values of 1.2, 1.5, 2, 5, 10 or 15 bar (absolute) or even higher. Where polymerization reactions are carried out at below atmospheric pressure, the pressures set are 950 mbar, frequently 900 mbar, and often 850 mbar (absolute). Advantageously the free-radical initiated polymerization of the invention is carried out at 1 atm (absolute) under an inert gas atmosphere, such as under nitrogen or argon, for example.

For the preparation of the polymer B used in accordance with the invention by free-radically initiated aqueous emulsion polymerization it is common to use dispersing assistants, which maintain not only the monomer droplets but also the particles of polymer B that are obtained by the free-radically initiated polymerization in disperse distribution in the aqueous phase and so ensure the stability of the aqueous polymer dispersion produced. Suitable such dispersing assistants include not only emulsifiers but also the protective colloids that are typically used for implementing free-radical aqueous emulsion polymerizations.

Examples of suitable protective colloids include polyvinyl alcohols, cellulose derivatives, and vinylpyrrolidone copolymers. A comprehensive description of further suitable protective colloids is found in Houben-Weyl, Methoden der organischen Chemie, Volume XIV/1, Makromolekulare Stoffe [Macromolecular compounds], pages 411 to 420, Georg-Thieme-Verlag, Stuttgart, 1961.

It will be appreciated that mixtures of emulsifiers and/or protective colloids can also be used. It is nevertheless advantageous, as dispersing assistants, to use exclusively emulsifiers, whose relative molecular weights, in contrast to those of the protective colloids, are typically below 1000. They may be anionic, cationic or nonionic in nature. Of course, where mixtures of surface-active substances are used, the individual components must be compatible with one another, something which in case of doubt can be checked by means of a few preliminary tests. In general, anionic emulsifiers are compatible with one another and with nonionic emulsifiers. The same applies to cationic emulsifiers, whereas anionic and cationic emulsifiers are usually not compatible with one another.

Examples of common place emulsifiers are ethoxylated mono-, di-, and tri-alkylphenols (EO degree: 3 to 50, alkyl radical: C₄ to C₁₂), ethoxylated fatty alcohols (EO degree: 3 to 50; alkyl radical: C₈ to C₃₆), and also alkali metal salts and ammonium salts of alkyl sulfates (alkyl radical: C₈ to C₁₂), of sulfuric monoesters with ethoxylated alkanols (EO degree: 3 to 30, alkyl radical: C₁₂ to C₁₈) and with ethoxylated alkylphenols (EO degree: 3 to 50, alkyl radical: C₄ to C₁₂), of alkylsulfonic acids (alkyl radical: C₁₂ to C₁₈), and of alkylarylsulfonic acids (alkyl radical: C₉ to C₁₈). Further suitable emulsifiers are found in Houben-Weyl, Methoden der organischen Chemie, Volume XIV/1, Makromolekulare Stoffe [Macromolecular compounds], pages 192 to 208, Georg-Thieme-Verlag, Stuttgart, 1961.

Compounds which have proven themselves further as surface-active substances are compounds of the general formula I

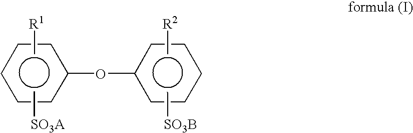

in which R¹ and R² are C₄ to C₂₄ alkyl and one of the radicals R¹ and R² may also be hydrogen, and A and B may be alkali metal ions and/or ammonium ions. In the general formula I, R¹ and R² are preferably linear or branched alkyl radicals having 6 to 18 C atoms, more particularly having 6, 12, and 16 C atoms, or H atoms, but R¹ and R² are not both simultaneously H atoms. A and B are preferably sodium, potassium or ammonium ions, with sodium ions being particularly preferred. Particularly advantageous compounds I are those in which A and B are sodium ions, R¹ is a branched alkyl radical with 12 C atoms, and R² is an H atom or R¹. Use is frequently made of technical mixtures which contain a fraction of 50% to 90% by weight of the monoalkylated product, an example being Dowfax® 2A1 (trade mark of the Dow Chemical Company). The compounds I are general knowledge—from U.S. Pat. No. 4,269,749, for example—and are available commercially.

For preparing the polymer B it is preferred to use exclusively nonionic and/or anionic emulsifiers.

In general the amount of dispersing assistant used, more particularly of emulsifiers, is 0.1% to 10% by weight, preferably 1% to 5% by weight, based in each case on the total amount of monomers B.

In general the polymer B used in accordance with the invention is prepared advantageously by charging a polymerization vessel at 20 to 25° C. (room temperature) and atmospheric pressure, under an inert gas atmosphere, with at least one portion of the deionized water used, if desired a portion of the free-radical initiator, of the dispersing assistant, and of the monomers B1 and B2, and subsequently heating this initial-charged mixture to the appropriate polymerization temperature, with stirring, and thereafter metering any remainder or the total amount of the free-radical initiator, dispersing assistant, and monomers B1 and B2 to the aqueous polymerization mixture under polymerization conditions.

The aqueous polymer dispersions obtained typically have polymer solids contents in terms of polymer B of ≧10% and ≦70% by weight, frequently ≧20% and ≦65% by weight, and often ≧40% and ≦60% by weight, based in each case on the aqueous polymer dispersion. The number-average particle diameter of the emulsion polymers B (cumulant z-average) as determined via quasielastic light scattering (ISO standard 13321) is generally between 10 and 2000 nm, advantageously between 20 and 1000 nm, and with particular advantage between 50 and 700 nm or 80 to 400 nm.

When preparing the polymer B by free-radically initiated aqueous emulsion polymerization, it will be appreciated that it is also possible to use further, optional auxiliaries familiar to the skilled worker, such as, for example, what are known as thickeners, defoamers, neutralizing agents, buffer substances, preservatives and/or free-radical chain transfer compounds.

The aqueous binder of the invention comprises not only the polymer A and the polymer B but also a polyol C which contains at least 2 hydroxyl groups. It is advantageous in this context to use those polyols C which are not volatile at the temperatures of drying and/or curing and which therefore have a correspondingly low vapor pressure.

This polyol C may in principle be a compound having a molecular weight ≦1000 g/mol or a polymeric compound having a molecular weight >1000 g/mol. Examples of polymeric compounds having at least 2 hydroxyl groups include polyvinyl alcohol, partly hydrolyzed polyvinyl acetate, homopolymers or copolymers of hydroxyalkyl acrylates or hydroxyalkyl methacrylates, such as hydroxyethyl acrylate or methacrylate or hydroxypropyl acrylate or methacrylate, for example. Examples of further polymeric polyols C are given in WO 97/45461, page 3, line 3 to page 14, line 33, among other publications.

Compounds contemplated as polyol C with a molecular weight <1000 g/mol include all those organic compounds which have at least 2 hydroxyl groups and a molecular weight <1000 g/mol. Mention may be made exemplarily of ethylene glycol, 1,2-propylene glycol, 1,2,3-propanetriol (glycerol), 1,2- and 1,4-butanediol, pentaerythritol, trimethylolpropane, sorbitol, sucrose, glucose, 1,2-, 1,3- and 1,4-dihydroxybenzene, 1,2,3-trihydroxybenzene, 1,2-, 1,4- and 1,4-dihydroxycyclohexane, and also preferably alkanolamines, such as, for example, compounds of the general formula II,

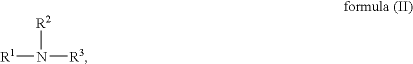

in which R¹ is an H atom, a C₁-C₁₀ alkyl group or a C₂-C₁₀ hydroxyalkyl group, and R² and R³ are a C₂-C₁₀ hydroxyalkyl group.

With particular preference R² and R³ independently of one another are a C₂-C₅ hydroxyalkyl group, and R¹ is an H atom, a C₁C₅ alkyl group or a C₂-C₅ hydroxyalkyl group.

Compounds of the formula II include more particularly diethanolamine, triethanolamine, diisopropanolamine, triisopropanolamine, methyldiethanolamine, butyldiethanolamine and/or methyldiisopropanolamine.

Examples of further polyols C having a molecular weight ≦1000 g/mol are likewise found in WO 97/45461, page 3, line 3 to page 14, line 33.

The polyol C is preferably selected from the group comprising diethanolamine, triethanolamine, diisopropanolamine, triisopropanolamine, methyldiethanolamine, butyldiethanolamine and/or methyldiisopropanolamine, with triethanolamine being more particularly preferred.

For the inventively useful aqueous binders, the polymer A, the polymer B, and the polyol C are used preferably in a quantitative ratio to one another such that the weight ratio (based on solids) of polymer A to polymer B is 100:1 to 1:100, advantageously 50:1 to 1:50, and with particular advantage 10:1 to 1:10, and the weight ratio (based on solids) of polymer A to polyol C is 100:1 to 1:3, advantageously 50:1 to 1:2, and with particular advantage 10:1 to 1:1.

The preparation of the inventive aqueous binders is familiar to the skilled worker and is accomplished, for example, in a simple way by mixing of the aqueous polymer A solutions and of the aqueous polymer B dispersions with the polyol C, or by preparing the polymer B in an aqueous medium in the presence of the polymer A, and adding the polyol C to the resulting aqueous polymer mixture.

The aforementioned aqueous binders comprise preferably less than 1.5%, more particularly less than 1.0%, more preferably less than 0.5%, and very preferably less than 0.3% by weight, more particularly less than 0.1% by weight, based on the sum of polymer A, polymer B, and polyol C (based on solids), of a phosphorus-containing reaction accelerant. Phosphorus-containing reaction accelerants are disclosed in, for example, EP-A 583086 and EP-A 651088. They include, more particularly, alkali metal hypophosphites, phosphites, polyphosphates, and dihydrogenphosphates, polyphosphoric acid, hypophosphoric acid, phosphoric acid, alkylphosphinic acid, or oligomers and/or polymers of these salts and acids.

The aqueous binders preferably comprise no phosphorus-containing reaction accelerants or no amounts of a phosphorus-containing compound that are active in accelerating the reaction. The binders of the invention may, however, comprise esterification catalysts familiar to the skilled worker, such as, for example, sulfuric acid or p-toluenesulfonic acid, or titanates or zirconates.

Furthermore, the aqueous binders of the invention may also comprise further, optional auxiliaries familiar to the skilled worker, such as, for example, what are known as thickeners, defoamers, neutralizing agents, buffer substances, preservatives, finely divided inert fillers, such as aluminum silicates, quartz, precipitated or fumed silica, light or heavy spar, talc or dolomite, coloring pigments, such as titanium white, zinc white or black iron oxide, adhesion promoters and/or flame retardants.

Where the aqueous binders of the invention are to be used as binders for mineral fibers and/or glass fibers or webs produced from them, advantageously ≧0.001% and ≦5% by weight, and with more particular advantage ≧0.05% and ≦2% by weight, based on the sum of the total amounts of polymer A, polymer B and polyol C (based on solids), of at least one silicon-containing adhesion crosslinker familiar to the skilled worker is added to the aqueous binders, such as, for example, an alkoxysilane, such as methyltrimethoxysilane, n-propyltrimethoxysilane, n-octyltrimethoxysilane, n-decyl-triethoxysilane, n-hexadecyltrimethoxysilane, dimethyldimethoxysilane, trimethyl-methoxysilane, 3-acetoxypropyltrimethoxysilane, 3-aminopropyltrimethoxysilane, 3-aminopropyltriethoxysilane, 3-chloropropyltrimethoxysilane, (3-glycidyloxypropyl)-trimethoxysilane, 3-mercaptopropyltrimethoxysilane and/or phenyltrimethoxysilane, with particular preference being given to functionalized alkoxysilanes, such as 3-acetoxypropyltrimethoxysilane, 3-aminopropyltrimethoxysilane, 3-aminopropyl-triethoxysilane, 3-chloropropyltrimethoxysilane, (3-glycidyloxypropyl)trimethoxysilane and/or 3-mercaptopropyltrimethoxysilane.

The aqueous binders of the invention typically have solids contents (formed from the sum of polymer A, polymer B and polyol C reckoned as solids) of ≧5% and ≦70%, frequently ≧10% and ≦65%, and often ≧15% and ≦55%, by weight, based in each case on the aqueous binder.

The aqueous binders useful according to the invention typically have pH values (measured at 23° C.; diluted with deionized water to a solids content of 10% by weight) in the range of ≧1 and ≦10, advantageously ≧2 and ≦6, and with more particular advantage ≧3 and ≦5. The pH in this case may be set using all of the basic compounds that are familiar to the skilled worker. It is advantageous, however, to use those basic compounds which are not volatile at the temperatures during drying and/or curing, such as sodium hydroxide, potassium hydroxide or sodium carbonate, for example.

The aqueous binders of the invention are advantageously suitable for use as binders for granular and/or fibrous substrates. With advantage, therefore, the aqueous binders stated can be used in producing shaped articles from granular and/or fibrous substrates.

Granular and/or fibrous substrates are familiar to the skilled worker. Examples include wood chips, wood fibers, cellulose fibers, textile fibers, plastics fibers, glass fibers, mineral fibers or natural fibers such as jute, flax, hemp or sisal, but also cork chips, sand and also other organic or inorganic, natural and/or synthetic, granular and/or fibrous compounds whose longest extent, in the case of granular substrates, is ≦10 mm, preferably ≦5 mm, and more particularly ≦2 mm. It will be appreciated that the term “substrate” is also intended to comprise the fiber webs obtainable from fibers, such as, for example, those known as mechanically consolidated (needled for example) fiber webs or chemically bound fiber webs. With more particular advantage the aqueous binder of the invention is suitable as a formaldehyde-free binder system for the aforementioned fibers and fiber webs mechanically consolidated or chemically bound.

The process for producing a shaped article from a granular and/or fibrous substrate and the aforementioned aqueous binder is advantageously performed by applying the aqueous binder of the invention to a granular and/or fibrous substrate (impregnating), if desired shaping the granular and/or fibrous substrate treated (impregnated) with the aqueous binder, and then subjecting the treated (impregnated) granular and/or fibrous substrate to a thermal treatment step at a temperature ≧130° C., in the course of which the binder cures.

The impregnation of the granular and/or fibrous substrates is generally accomplished by applying the aforementioned aqueous binder uniformly to the surface of the granular and/or fibrous substrate. The amount of aqueous binder in this case is chosen such that ≧1 g and ≦100 g, preferably ≧2 g and ≦50 g, and with more particular preference ≧5 g and ≦30 g of binder (calculated as the sum of the total amounts of polymer A, polymer B and polyol C, based on solids) are used per 100 g of granular and/or fibrous substrate. The impregnation of the granular and/or fibrous substrate is familiar to the skilled worker and takes place, for example, by drenching or by spraying of the granular and/or fibrous substrate.

Following impregnation, the granular and/or fibrous substrate is brought if desired into the required form, by means, for example, of introduction into a heatable press or mold. Subsequently the shaped, impregnated granular and/or fibrous substrate is dried and cured in a manner familiar to the skilled worker.

Frequently the drying and/or curing of the impregnated granular and/or fibrous substrate, which if desired has been shaped, takes place in two temperature stages, the drying stage taking place at a temperature <130° C., preferably ≧20° C. and ≦120° C., and with more particular preference ≧40 and ≦100° C., and the curing stage taking place at a temperature of ≧130° C., preferably ≧150 and ≦250° C., and with more particular preference ≧180° C. and ≦220° C.

The drying stage in this case takes place advantageously such that drying at a temperature ≦100° C. is carried out until the shaped, impregnated granular and/or fibrous substrate, which frequently still does not have its ultimate shape (and is referred to as a semifinished product), has a residual moisture content ≦15%, preferably ≦12%, and with more particular preference ≦10% by weight. This residual moisture content is generally determined by first weighing approx. 1 g of the resulting semifinished product at room temperature, then drying it at 130° C. for 2 minutes, and subsequently cooling it and reweighing it at room temperature. In this case the residual moisture content corresponds to the difference in weight of the semifinished product before and after the drying operation, relative to the weight of the semifinished product before the drying operation, multiplied by a factor of 100.

The semifinished product obtained in this way is still deformable after heating to a temperature a ≧100° C., and at that temperature can be brought into the ultimate shape of the desired shaped article.

The subsequent curing stage takes place advantageously such that the semifinished product is heated at a temperature a ≧130° C. until it has a residual moisture content ≦3%, preferably ≦1% and with more particular preference ≦0.5% by weight, the binder curing as a consequence of an esterification reaction.

Frequently the shaped articles are produced by bringing the semifinished product into its ultimate shape in a shaping press, in the aforementioned temperature ranges, and subsequently curing it.

It will be appreciated, however, that it is also possible for the drying stage and the curing stage of the shaped articles to take place in one workstep, in a shaping press, for example.

The shaped articles obtainable by the process of the invention have advantageous properties, more particularly improved wet tensile strength and a significantly lower yellowing tendency as compared with the prior-art shaped articles.

The invention is elucidated with reference to the following nonlimiting examples.

### A. Preparation of Polymer A

### Polymer A

A 2 l four-neck flask equipped with an anchor stirrer, reflux condenser, and three metering devices was charged at 20 to 25° C. (room temperature) with 200.0 g of methyl ethyl ketone (MEK) and 41.0 g of maleic anhydride (MAn) under a nitrogen atmosphere. Subsequently the initial-charge solution was heated to 82° C. with stirring, and, beginning simultaneously, feed 1 was metered in over the course of 3 hours, feed 2 over the course of 5 hours, and feed 3 over the course of 5.5 hours, in each case continuously and with constant volume flows. Thereafter the reaction mixture was polymerized at the aforementioned temperature for 2 more hours, after which the resulting polymer solution was cooled to room temperature.

### Feed 1:

120.0 g MAn (in melted form)

### Feed 2:

373.4 g acrylic acid (AA)
109.4 g oct-1-ene and

### 217.0 g MEK

### Feed 3:

42.9 g a 75% strength by weight solution of tert-butyl perpivalate in an aromatic-free hydrocarbon mixture (Akzo Nobel) and

### 184.0 g MEK

Subsequently 1200 g of the organic polymer solution obtained were diluted with 700 g of deionized water, and an MEK/water mixture was distilled off on a rotary evaporator at a bath temperature of 80° C. until the internal pressure was 20 mbar (absolute). After that, deionized water was added to set a solids content of 51.6% by weight. The K value of the polymer A was found to be 15.0, and its weight-average molecular weight 11 700 g/mol.

The solids content was generally determined by drying a sample of approximately 1 g in a forced-air drying oven at 120° C. for two hours. Two separate measurements were carried out in each case. The figures reported in the examples are averages of the two results.

The K value of the polymer A was determined by the method of Fikentscher (ISO 1628-1) by means of a 1% strength by weight aqueous polymer solution.

The weight-average molecular weight of the polymer A was determined by means of gel permeation chromatography (linear column: Supremea M from PSS, eluent: 0.08 mol/l TRIS buffer pH 7.0, deionized water, liquid flow rate: 0.8 ml/min, detector: ERC 7510 differential refractometer from ERC).

### Comparative Polymer CA

Comparative polymer CA was prepared in the same way as for polymer A, but without oct-1-ene being used in feed 2.

Deionized water was added to set a solids content of 46.0% by weight. The K value of comparative polymer CA was found to be 16.5 and its weight-average molecular weight 12 500 g/mol.

### B. Preparation of Polymer B

### Polymer Dispersion B

A 5 l reactor with anchor stirrer, heating and cooling facilities, and various metering devices was charged with the initial charge at room temperature and under a nitrogen atmosphere, and this initial charge was heated with stirring to 90° C. and then maintained at that temperature. Thereafter 0.75 g of feed 2 was metered over the course of a minute into the aqueous polymerization medium, and the resulting mixture was stirred for 5 minutes. After that the total amounts of feeds 1 and 3 and also the remainder of feed 2 were metered into the aqueous reaction medium, beginning simultaneously and over the course of 3 hours, with constant volume flows. Subsequently feed 4 was metered in over the course of 30 minutes with a constant volume flow, followed by polymerization at 90° C. for 30 minutes. Thereafter the temperature was lowered to 70° C. and, beginning simultaneously, feeds 5 and 6 were metered in over a period of 60 minutes with constant volume flows. After that the aqueous polymer dispersion obtained was cooled to room temperature and filtered through a 125 μm filter.

### Initial Charge:

332.5 g deionized water
6.8 g the 51.6% strength by weight aqueous solution of polymer A

### Feed 1:

671.5 g the 51.6% strength by weight aqueous solution of polymer A

### Feed 2:

14.0 g deionized water
1.0 g sodium persulfate

### Feed 3:

150.5 g n-butyl acrylate
164.5 g styrene
17.5 g 2-hydroxyethyl acrylate
17.5 g glycidyl methacrylate

### Feed 4:

9.3 g deionized water
0.7 g sodium persulfate

### Feed 5:

10.5 g a 10% strength by weight aqueous solution of tert-butyl hydroperoxide

### Feed 6:

10.3 g a 13.3% strength by weight aqueous solution of a 1:1 reaction product of acetone and sodium hydrogensulfite

The resulting aqueous polymer dispersion B had a pH of 1.5. The solids content was found to be 48.6% by weight, the viscosity 2160 mPas, the average particle size 157 nm, and the coagulum content 0.001% by weight.

The pH was determined generally using a handylab 1 pH meter from Schott at 23° C.

The viscosities of the aqueous polymer dispersions were determined generally in accordance with DIN 53019 using a Physika Rheomat at 23° C. and a shear rate of 250 s⁻¹.

The average particle size was determined generally by the method of quasielastic light scattering (DIN ISO 13321) using a high performance particle sizer (HPPS) from Malvern Instruments Ltd.

The coagulum contents were determined generally by rinsing the 125 μm filter, after filtration, with 100 ml of deionized water, then drying the product in a drying oven at 140° C. for 30 minutes and subsequently weighing it at room temperature. The respective coagulum content corresponds to the difference in weight of the filter before and after filtration, based on the solids content of the respective polymer dispersion.

### Comparative Polymer Dispersion CB

Comparative polymer dispersion CB was prepared in exactly the same way as polymer dispersion B, with the difference that the initial charge contained 7.6 g and as feed 1 753.2 g of the 46% strength by weight aqueous solution of comparative polymer CA, instead of 6.8 g in the initial charge and 671.5 g, as feed 1, of the 51.6% strength by weight aqueous solution of polymer A. Furthermore, in the initial charge, the amount of deionized water was reduced from 332.5 g to 250.8 g.

The resulting aqueous comparative polymer dispersion CB had a pH of 1.6. The solids content was found to be 48.4% by weight, the viscosity 1960 mPas, the average particle size 309 nm, and the coagulum content 0.6% by weight.

### C. Performance Investigations

Glass fiber webs measuring 32×28 cm, with a basis weight of 50 g/m², from Schuller GmbH, Wertheim, were used.

The aforementioned aqueous polymer dispersions B and CB were admixed at room temperature and with stirring with an amount of triethanolamine sufficient for the aqueous dispersions to comprise 9 parts by weight of triethanolamine per 100 parts by weight of polymer (corresponding to the total amount of polymer A/CA and B). Subsequently the resulting aqueous polymer dispersions were diluted with deionized water to a solids content (corresponding to the total amount of polymer NCA and B and also triethanolamine [solids/solids]) of 25% by weight. After that the glass fiber webs were passed in longitudinal direction over a continuous PES sieve belt with a belt running speed of 60 cm per minute through the aforementioned 25% strength by weight aqueous binder liquors. Through subsequent suction removal of the aqueous binder liquors, the wet add-on was set at 40 g/m² (corresponding to 10 g/m² binder, reckoned as solids). The impregnated glass fiber webs obtained in this way were dried/cured in a Mathis oven, on a plastic net support, either at 160° C. for 2 minutes or at 180° C. for 2 minutes, with the maximum hot-air flow. After the webs had been cooled to room temperature, test strips measuring 240×50 mm were cut in the longitudinal direction of the fiber. The test strips obtained were then stored in a climate chamber at 23° C. and 50% relative humidity for 24 hours. The glass fiber web test strips obtained are referred to below, as a function of the polymer dispersion used for the aqueous binder, as test strips B and CB.

### Determination of Yellowing

The yellowing was determined using a Lange colorimeter in a method based on DIN 5033 and DIN 6174. The test strips B and CB were tested against a white test tile. For testing, 6 test strips in each case were placed over one another. As a measure of the yellowing, the b* value was determined (the CIELab System describes color exactly in a color space formed from three coordinate axes: L: luminance, a*: red-green axis, b*: yellow-blue axis. The rule here is that the higher the b* values, the more yellow the test strips). 3 measurements were carried out in each case. The figures reported in table 1 represent in each case the average of these measurements.

### Determination of Wet Tensile Strength

Prior to the determination of the wet tensile strength, test strips B and CB were stored in deionized water at 80° C. for 15 minutes, then cooled to room temperature and dabbed dry with a cotton fabric. This was followed by measurement on a Zwick-Roell Z005 tensile testing machine. Test strips B and CB were introduced vertically into a clamping apparatus such that the free clamped-in length was 200 mm. Subsequently the clamped-in test strips were pulled apart in opposite directions at room temperature at a speed of 25 mm per minute until the test strips tore. The higher the force needed to tear the test strips, the better the evaluation of the corresponding tensile strength. 5 measurements were carried out in each case. The figures likewise reported in table 1 represent in each case the average of these measurements.

TABLE 1
Compilation of the results

| | Curing at 160° C. | | Curing at 180° C. | |
|---|---|---|---|---|
| | | Wet tensile | | Wet tensile |
| | Yellowing | strength | Yellowing | strength |
| Test strip | [b* value] | [N/50 mm] | [b* value] | [N/50 mm] |
| B | 1.6 | 96 | 2.5 | 127 |
| CB | 2.5 | 86 | 6.2 | 103 |

From the results it is clearly apparent that the test strips obtained using the aqueous binders of the invention exhibit a markedly improved wet tensile strength behavior and also a significantly lower yellowing.

1. An aqueous binder for granular and/or fibrous substrates, comprising as active constituents
a) a polymer obtainable by free-radical addition polymerization and comprising in copolymerized form
0.1% to 40% by weight of at least one C₃ to C₃₀ alkene (monomer A1),
40% to 99.9% by weight of at least one ethylenically unsaturated C₃ to C₆ monocarboxylic acid (monomer A2),
0% to 50% by weight of at least one ethylenically unsaturated C₄ to C₁₂ dicarboxylic acid and/or of the ethylenically unsaturated dicarboxylic monoalkyl esters or dicarboxylic anhydrides obtainable from said acid (monomer A3), and
0% to 30% by weight of at least one other ethylenically unsaturated compound which is copolymerizable with the monomers A1 to A3 (monomer A4),
the amounts of monomers A1 to A4 adding up to 100% by weight [polymer A],
b) a polymer obtainable by free-radical addition polymerization and comprising in copolymerized form 0.1% to 15% by weight of at least one ethylenically unsaturated compound containing at least one carboxyl, hydroxyalkyl, epoxy, methylol, silyl and/or oxazolinyl group [monomer B1] and 85% to 99.9% by weight of at least one other ethylenically unsaturated compound [monomer B2] which is copolymerizable with the monomer B1, the amounts of monomers B1 and B2 adding up to 100% by weight [polymer B], and
c) a polyol compound having at least two hydroxyl groups [polyol C].

2. The aqueous binder according to claim 1, the polymer A being composed in copolymerized form of:
1% to 25% by weight of at least one monomer A1,
50% to 89% by weight of at least one monomer A2, and
10% to 40% by weight of at least one monomer A3.

3. The aqueous binder according to either of claims 1 and 2, the at least one monomer A1 being oct-1-ene and/or dec-1-ene, the at least one monomer A2 being acrylic acid and/or methacrylic acid, and the at least one monomer A3 being maleic acid, itaconic acid, methylmaleic acid, 1,2,3,6-tetrahydrophthalic acid, maleic anhydride, itaconic anhydride, methylmaleic anhydride and/or 1,2,3,6-tetrahydrophthalic anhydride.

4. The aqueous binder according to any of claims 1 to 3, the polymer B being composed in copolymerized form of:
4% to 12% by weight of at least one monomer B1 and
88% to 96% by weight of at least one monomer B2.

5. The aqueous binder according to any of claims 1 to 4, monomer B1 being selected from the group comprising acrylic acid, methacrylic acid, crotonic acid, fumaric acid, maleic acid, maleic anhydride, methylmaleic acid, itaconic acid, 2-hydroxyethyl acrylate, 2-hydroxyethyl methacrylate, 2-hydroxypropyl acrylate, 2-hydroxypropyl methacrylate, 4-hydroxybutyl acrylate, diethylene glycol monoacrylate, 4-hydroxybutyl vinyl ether, glycidyl acrylate, glycidyl methacrylate, N-methylolacrylamide, N-methylolmethacrylamide, 2-isopropenyl-2-oxazoline, 5-(2-oxazolinyl)pentyl methacrylate, (3-methacryloyloxypropyl)trimethoxysilane, vinyltriacetoxysilane, and vinyltriethoxysilane.

6. The aqueous binder according to claims 1 to 5, the polymer B being composed in copolymerized form of:
40% to 56% by weight of styrene,
40% to 56% by weight of n-butyl acrylate,
2% to 7% by weight of 2-hydroxyethyl acrylate, and
2% to 7% by weight of glycidyl methacrylate.

7. The aqueous binder according to any of claims 1 to 6, the polyol C being an alkanolamine.

8. The aqueous binder according to any of claims 1 to 7, the polyol C being a triethanolamine.

9. The aqueous binder according to any of claims 1 to 8, the weight ratio of polymer A to polymer B (based on solids) being 100:1 to 1:100 and the weight ratio of polymer A to polyol C (based on solids) being 100:1 to 1:3.

10. The use of an aqueous binder according to any of claims 1 to 9 as a binder in producing a shaped article from a granular and/or fibrous substrate.

11. A process for producing a shaped article from granular and/or fibrous substrates, which comprises applying an aqueous binder according to any of claims 1 to 9 to the granular and/or fibrous substrate, if desired shaping the granular and/or fibrous substrate treated with the aqueous binder, and then subjecting the treated granular and/or fibrous substrate to a thermal treatment step at a temperature ≧130° C.

12. The process according to claim 11, wherein ≧1 g and ≦100 g of binder (calculated as the sum of the total amounts of polymer A, polymer B, and polyol C, based on solids) are used per 100 g of granular and/or fibrous substrate.

13. The process according to claim 11 or 12, wherein the granular and/or fibrous substrate is a mechanically consolidated or chemically bound fiber web.

14. A shaped article obtainable by a process according to any of claims 11 to 13.
